(19) United States
(12) Patent Application Publication
(10) Pub. No.: US 2025/0233543 A1
(43) Pub. Date: Jul. 17, 2025

(54) SELF-CLOSING PHOTOVOLTAIC MODULE-TO-TORQUE TUBE RAIL

(71) Applicant: Terabase Energy, Inc., Berkeley, CA (US)

(72) Inventor: Adam Hansel, Davis, CA (US)

(73) Assignee: Terabase Energy, Inc., Berkeley, CA (US)

(21) Appl. No.: 18/828,336

(22) Filed: Sep. 9, 2024

Related U.S. Application Data
(60) Provisional application No. 63/620,487, filed on Jan. 12, 2024.

(51) Int. Cl. H02S 20/20

(52) U.S. Cl. CPC H02S 20/20

(57) ABSTRACT

In solar systems, the installation process for solar module-to-torque tube is typically implemented manually by an installer. Such a manual process negatively impacts cost-effectiveness and installation consistency, especially for large solar systems. The present invention discloses embodiments of a self-closing rail that facilitates an automatic installation process for a torque tube for improved efficiency. The self-closing rail may use various structures and functions disclosed herein to keep rail arms open such that the torque tube may be unobstructively moved to a correct position for installation. The rail arms may have a shape matching or partially matching the cross-sectional shape of the torque tube for a tight fit of the torque tube.

### CROSS-REFERENCE TO RELATED APPLICATION

This application claims the priority benefit under 35 U.S.C. § 119 (e) to U.S. Provisional Patent Application No. 63/620,487, filed on Jan. 12, 2024, entitled “SELF-CLOSING PHOTOVOLTAIC MODULE-TO-TORQUE TUBE RAIL” and listing Adam Hansel as inventor. The aforementioned patent document is incorporated by reference herein in its entirety.

### TECHNICAL FIELD

The present disclosure relates generally to solar panel installation. More particularly, the present disclosure relates to self-closing rail that facilitates automatic installation process for solar module assembly for improved efficiency.

### BACKGROUND

The importance of solar power systems is well understood by one of skill in the art. Government agencies and companies are scaling the size and number of solar solutions within their energy infrastructure. This transition from traditional fossil fuel energy systems to solar energy solutions presents several challenges. One challenge is cost-effective management of the construction process and the ability to improve on-site installation efficiency during the construction process.

FIG. 1 shows a typical solar farm 105 comprising an array of installed solar tables 110. Each table comprises multiple solar panels 115. A large-scale solar farm typically includes thousands of solar panels that are located across a multi-acre terrain and that are electrically coupled to provide a source of energy. These large-scale systems are oftentimes located in remote areas and require a significant investment in materials, resources, and labor for on-site installation. It can be very challenging to maintain consistent installation processes at each point of installation within a construction site across large areas. These issues further contribute to an increase in the cost and complexity of a very cost-sensitive process.

In a typical installation process, multiple solar panels are securely aligned and attached to a shaft or torque tube (TT) to form a row of solar panels. A solar farm may comprise one or more solar arrays, with each solar array having multiple rows of solar panels. A row of solar panels may be supported by ground piles with the torque tube securely fastened to ground piles at a desired rotational angle such that the solar panels are oriented for maximum energy production efficiency.

To attach a solar panel to a torque tube, an installer may need to attach the panel frames of the solar panel to one or more mounting brackets (also referred to as rails), which are secured to the torque tube. A typical solar module-to-torque tube installation process is implemented manually by an installer. Such a manual process negatively impacts cost-effectiveness and installation consistency, especially for large solar systems.

What is needed are systems, devices, and methods that facilicate installation automation to improve the efficiency of solar module-to-torque tube installation of large-scale solar panel systems.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that the description is not intended to limit the scope of the invention to these particular embodiments. Items in the figures may be not to scale.

FIG. 1 depicts a typical large-scale solar farm comprising an array of installed solar tables, with each solar table comprising multiple solar panels.

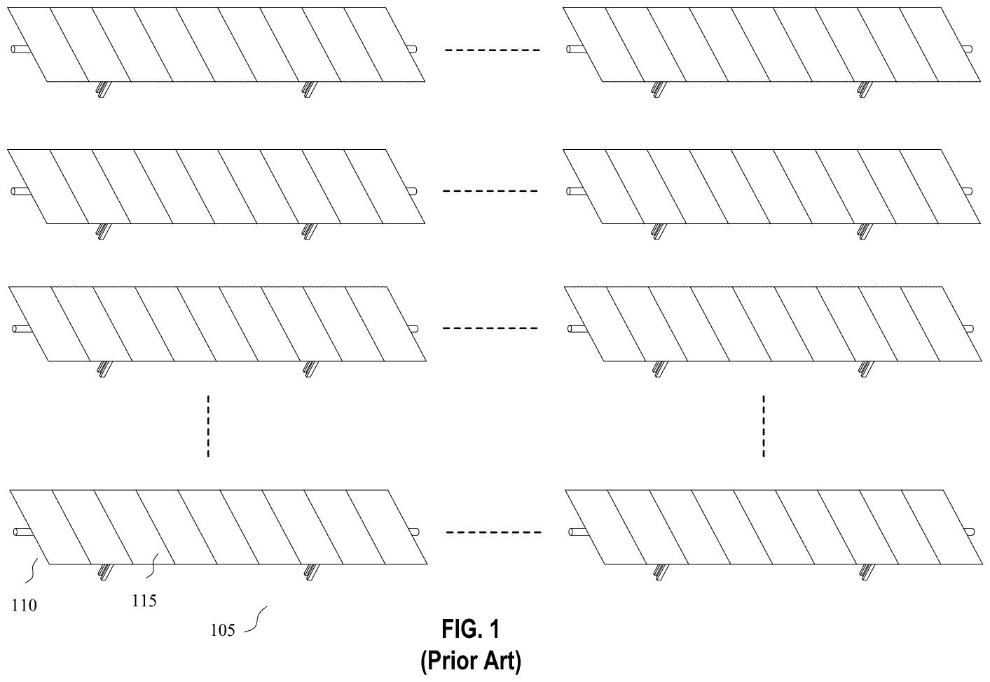

FIG. 2 shows an installation of solar tables on a construction site.

FIG. 3 shows a prior art rail with an open strap.

FIG. 4 shows a prior art rail with a closed strap.

FIG. 5 shows another prior art rail for an octagonal torque tube.

FIG. 6 shows a prior art rail with free swing arms.

FIG. 7 shows a rail with a spring to hold arms open in accordance with various embodiments of the invention.

FIG. 8 shows an operation sequence of a self-closing rail with a cam in accordance with various embodiments of the invention.

FIG. 9 shows a self-closing rail with push arms in an open state in accordance with various embodiments of the invention.

FIG. 10 shows a self-closing rail with push arms in a closed state in accordance with various embodiments of the invention.

### DETAILED DESCRIPTION OF EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method.

Components, or features, shown in diagrams are illustrative of exemplary embodiments of the invention and are meant to avoid obscuring the invention. It shall also be understood that throughout this discussion components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in a variety of mechanical structures supporting corresponding functionalities of a self-closing rail.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A component, function, or structure is not limited to a single component, function, or structure; usage of these terms may refer to a grouping of related components, functions, or structures, which may be integrated and/or discrete.

Further, it shall be noted that: (1) certain components or functionals may be optional; (2) components or functions may not be limited to the specific description set forth herein; (3) certain components or functions may be assembled/combined differently; and (4) certain functions may be performed concurrently or in sequence.

Furthermore, it shall be noted that many embodiments described herein are given in the context of the assembly and installation of large numbers of solar panels within a system, but one skilled in the art shall recognize that the teachings of the present disclosure may apply to other large and complex construction sites in which resources and personnel are difficult to manage and accurately predict. Additionally, embodiments of solar module-to-torque tube rails may be implemented in smaller construction sites or construction sites for applications other than solar farms.

In this document, “large-scale solar system” refers to a solar system having 1000 or more solar panels. The word “resources” refers to material, parts, components, equipment or any other items used to construct a solar table and/or solar system. The term “solar table” refers to a structural assembly comprising one or more photovoltaic (PV) or solar panels and/or one or more panel frames (or purlins) for panel support. Some types of solar panels may have electrical harnesses and supplemental structure that allow them to connect to other solar panels or foundations/piles while other types do not have this supplemental structure.

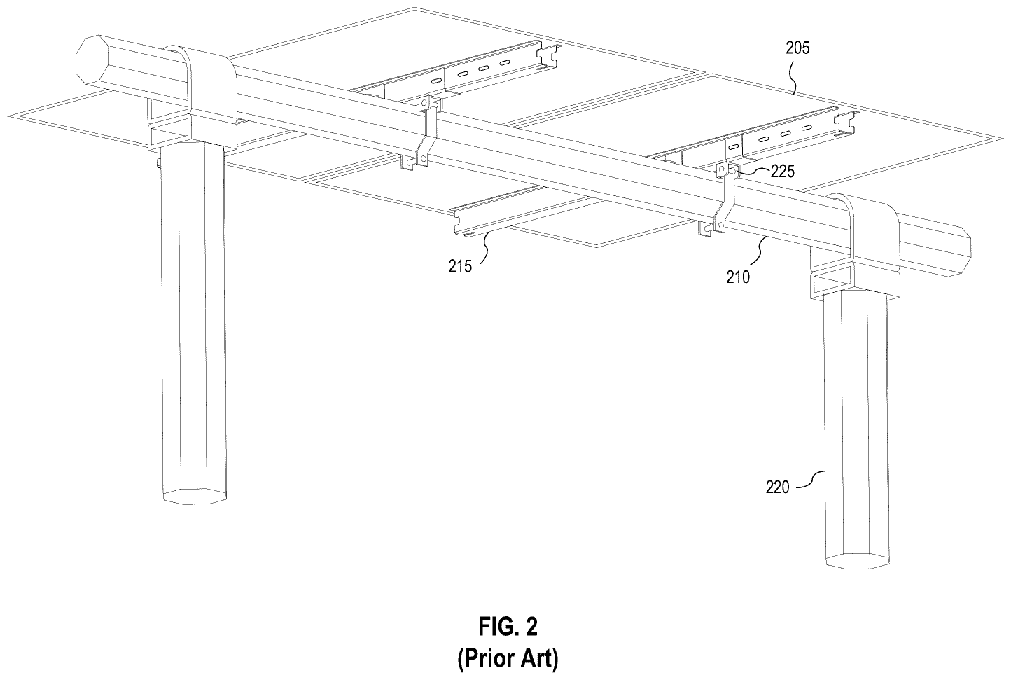

FIG. 2 shows an installation of solar panels in a construction site in accordance with various embodiments of the invention. Multiple solar panels 205 are securely aligned and attached to a shaft or torque tube 210 to form a row of solar panels, which are supported by ground piles 220. The torque tube is securely fastened to the ground piles and may be fixed in a desired rotational angle or be rotatable during operation such that the solar panels can operate continually under maximum energy production efficiency. To securely attach a solar panel to a torque tube, one or more panel frames 215 of the solar panel are firmly connected to a mounting bracket or rail 225, which is firmly clamped or coupled to the torque tube 210.

To improve automation potential for PV applications, it is preferable to design parts that are both repeatable in their alignment behavior and are reasonably easy to automate. Current rail designs do not have repeatable attachment features for the rail-to-TT attachment. As a result, the rail-to-TT installation is typically implemented manually.

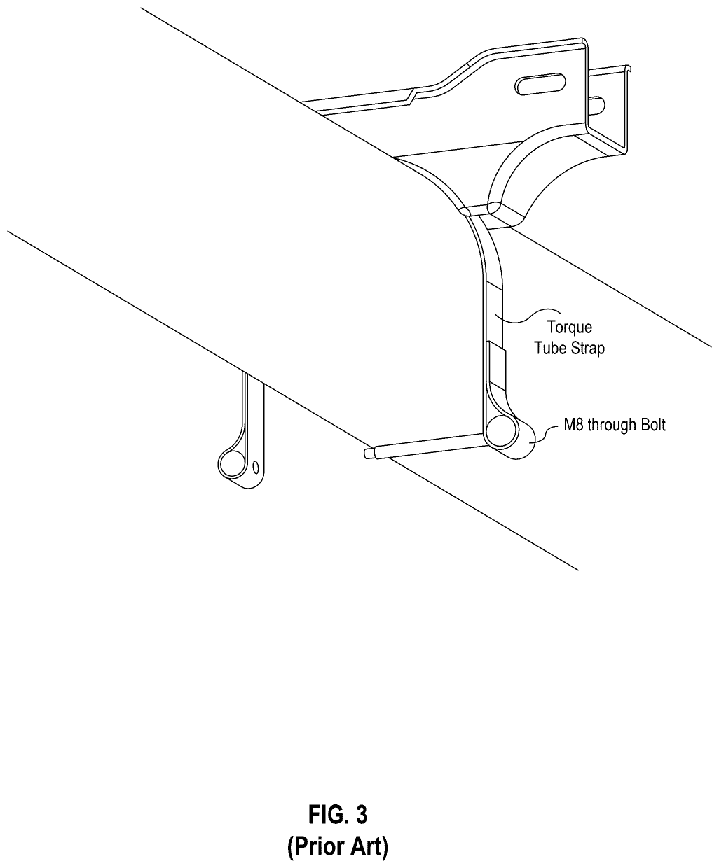

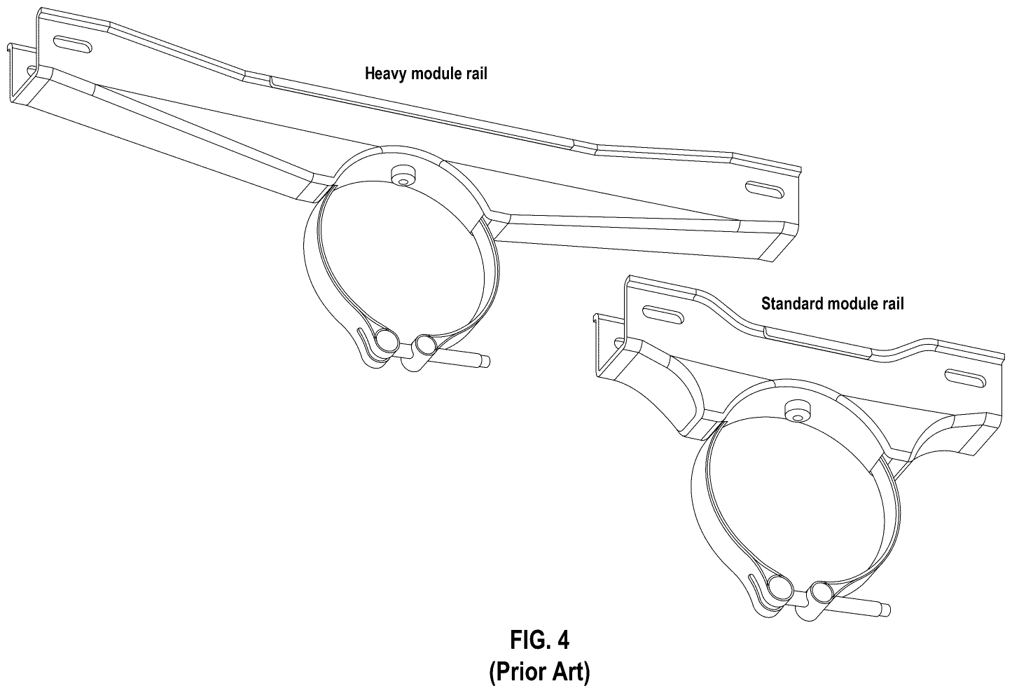

FIG. 3 shows a prior art rail with an open strap, and FIG. 4 shows such strap-based rails rail with a closed strap. The rail uses a metal strap. For installation, an installer would need to open the strap wide enough such that the torque tube may be lifted to touch a concave surface of the rail for installation. The manual opening of the strap would make it challenging for automatic rail-to-tube installation. The strap used in such a type of rail is floppy and compliant. As a result, the nut and bolt must be pulled together manually to fasten together, which may bring extra challenging for automatic bolt installation.

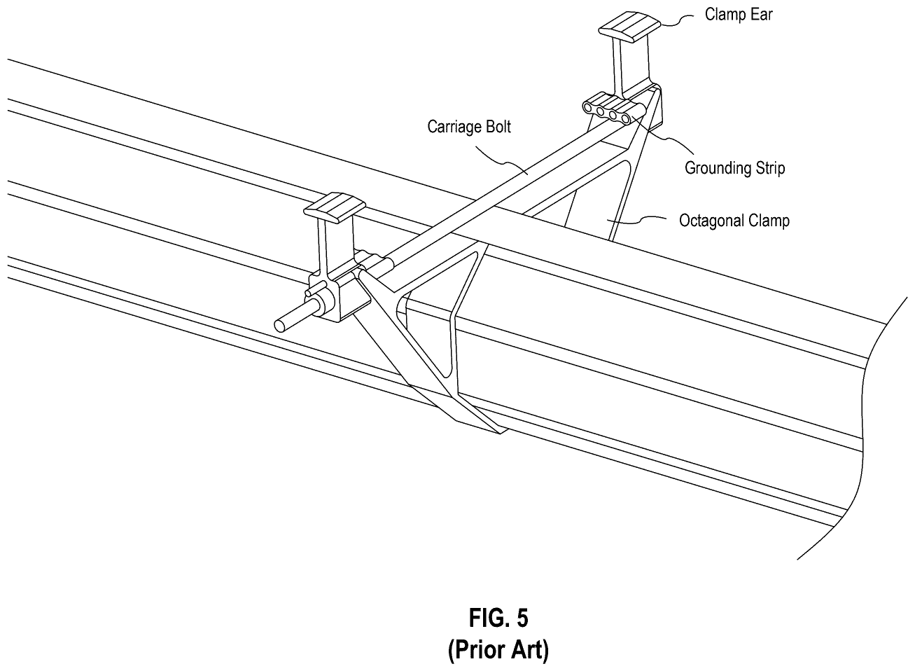

FIG. 5 shows another prior art rail for an octagonal torque tube. The rail has an octagonal clamp and relies on a carriage bolt for clamp tightening. With such a configuration, the rail cannot be directly attached to the torque tube without inserting it from one end of the torque tube and sliding longitudinally along the tube to a desired position. This pre-inserting requirement makes it difficult, if not impossible, to implement automatic rail-tube installation.

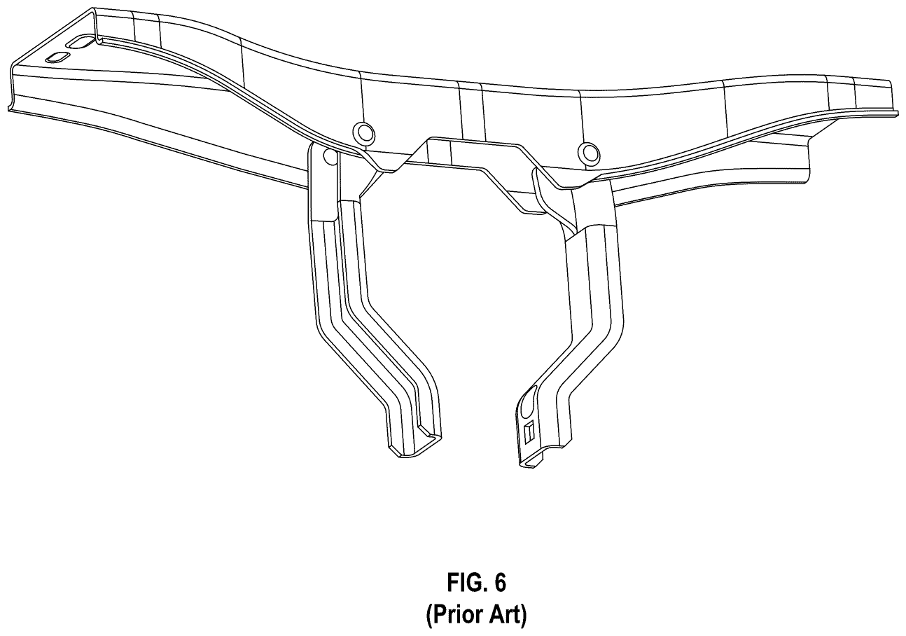

FIG. 6 shows a prior art rail with free swing arms. The rail has two rail arms that are free to swing around their pivot points and need to be manually opened and closed to attach to a torque tube. Human labor is required to compensate for the non-repeatable nature of such an opening and closing process. For automation, automatic equipment, e.g., a robot, is practically unable or difficult to consistently resolve these non-repeatable aspects for rail-tube installation.

Described hereinafter are embodiments of a self-closing rail that facilitates the automatic installation process for a torque tube for improved efficiency. The self-closing rail may use various structures and functions disclosed herein to keep rail arms open such that the torque tube may be unobstructively moved to the correct position for installation. The rail arms may have a shape matching or partially matching the cross-sectional shape of the torque tube for a tight fit of the torque tube. Advantages of self-closing rail embodiments are multifold. First, the invention ensures an unobtrusively, thus repeatable process for automatic movement of the torque tube toward the rail. Second, the invention guarantees a repeatable and reliable way to provide a grip around the torque tube when the rail arms are closed.

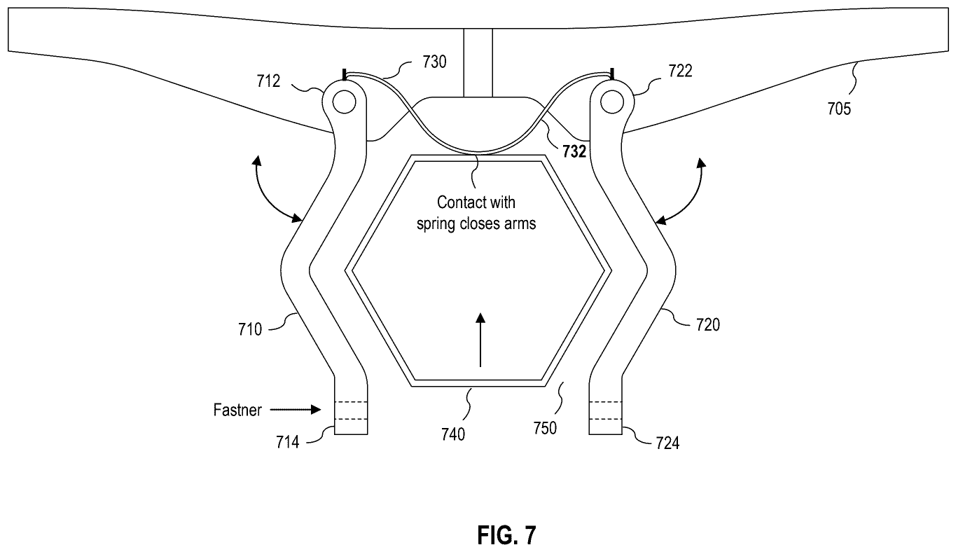

FIG. 7 shows a rail with a spring to hold the arm open in accordance with various embodiments of the invention. The rail has a rail body 705, a first arm 710, and a second arm 720. The first arm 710 has a first end 712 pivotably attached to the rail body 705. The second arm 720 has a first end 722 pivotably attached to the rail body 705. A spring 703 is engaged between the first end 712 of the first arm and the first end 722 of the second arm to keep both arms in an open state by default. In the open state, there is an open area 750 between the first arm and the second arm wide enough to receive a torque tube 740 unobtrusively.

In one or more embodiments, the spring 703 is a leaf spring having an arc section 732 facing toward the open area 750 between the first arm and the second arm. When a torque tube is moved (e.g., by a robot) toward the rail body 705 for installation, the torque tube pushes the spring 703 to expand. As a result, the first arm 710 and the second arm 720 are pivotably rotated to a closed state to hold the torque tube 740 in place. In the closed state a second end 714 of the first arm 710 and a second end 724 of the second arm 720 face each other and may be securely bolted together to lock the torque tube between the first arm and the second arm.

The first arm 710 and the second arm 720 may have or partially have an arm profile to match the shape of the torque tube 740 for a tight fit. As shown in FIG. 4, the torque tube 740 has an octagonal cross-section shape. The first arm 710 and the second arm 720 are bent arms with an octagonal bent angle (135°) to match the octagonal cross-section shape. Such a matching not only ensures a tight fit in the closed state but also provides an anti-rotation means after installation. Other embodiments of the invention may be used with different torque tube shapes such as round, square, rectangular or other shapes such that the first arm 710 and the second arm 720 may have a corresponding shape to enable a tight fit.

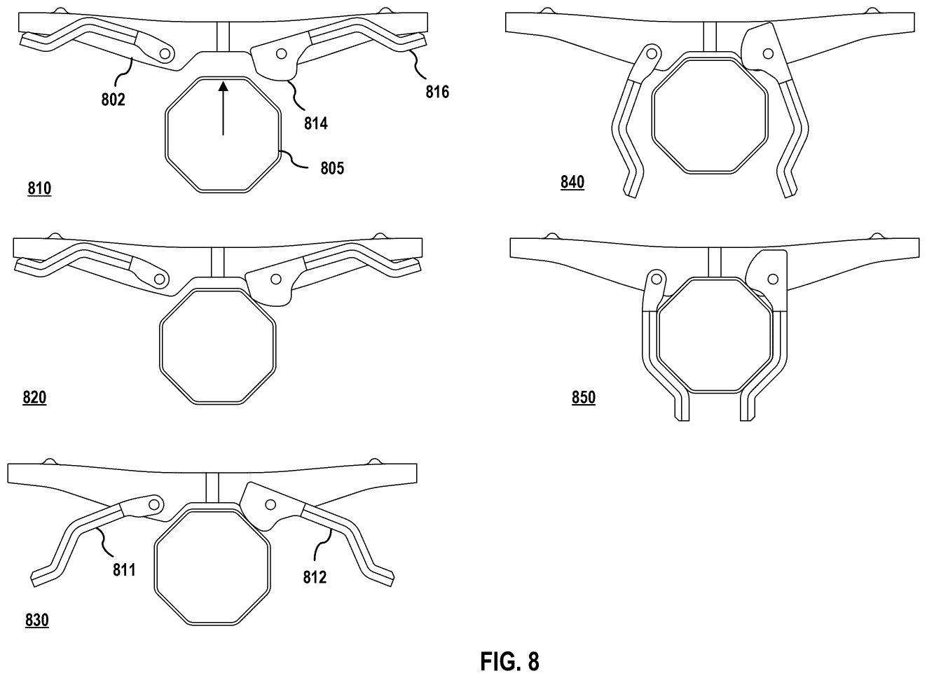

FIG. 8 shows an operation sequence of a self-closing rail with a cam in accordance with various embodiments of the invention. Similar to FIG. 7, the rail has a rail body 802, a first arm 811, and a second arm 812, both of which are pivotably attached to the rail body 802. Instead of using a spring coupled between the two arms, the first arm 811 and the second arm 812 may be kept in an open state utilizing a friction fit at each pivot axis engaging the rail arms or a torsional spring disposed at each pivot axis.

As shown in processes 810-850, the arms in FIG. 8 rely on a cam for arm closing. The arm 812 has a first end 814 pivotably attached to the rail body 802. The first end 814 is also a cam that touches a torque tube 805 when the torque tube moves towards the rail body 802. As the torque tube 805 comes closer to the rail body, static friction between the torque tube 805 and the cam causes the cam to follow the surface of the torque tube, resulting in a closed state for the arms when the torque tube is in a correct installation position.

The first arm 812 may be pivoted via a gear or link that synchronizes rotation of both arms. When the second arm 814 rotates, the first arm 812 is pivoted synchronously. Alternatively, a cam may also be disposed at a pivoting end of the first arm. It shall be noted that although only one cam on the second arm 812 is shown in FIG. 8, the cam may be used on both arms to engage the torque tube together.

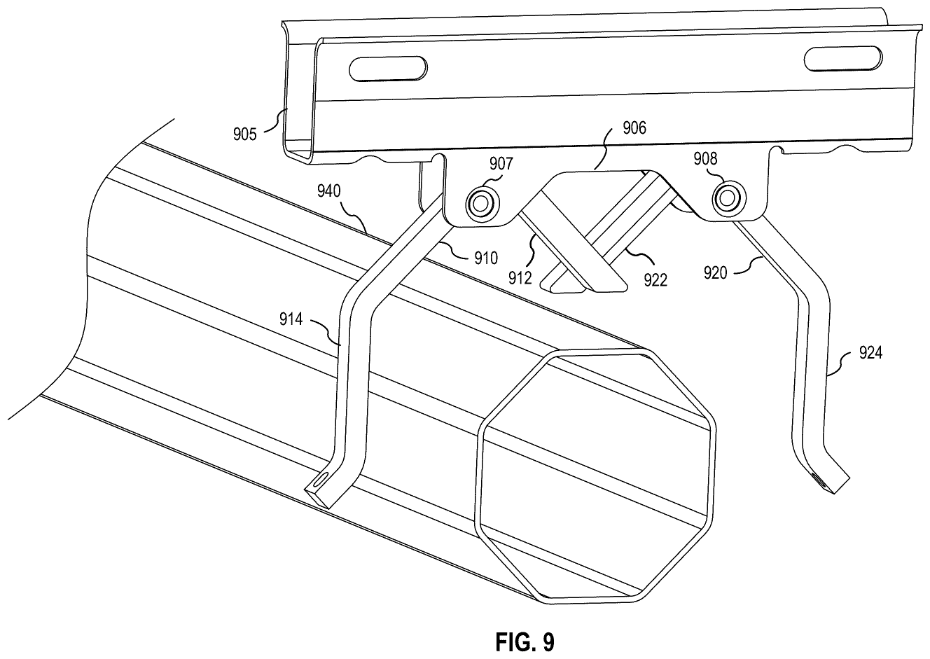

FIG. 9 shows a self-closing rail with push arms in an open state in accordance with various embodiments of the invention. The self-closing rail has a rail body 905, a first arm 910, and a second arm 920. The first arm 910 has a first section 912 and a second section 914. The first arm 910 is pivotably attached to the rail body 905 around a first pivot axis 907. The pivot connection of the first arm 910 is between the first section 912 and the second section 914. The second arm 920 has a first section 922 and a second section 924. The second arm 920 is pivotably attached to the rail body 905 around a second pivot axis 908. The pivot connection of the second arm 920 is between the first section 922 and the second section 924.

The first arm 910 and the second arm 920 are kept in an open state by default. In the open state, the second section 914 of the first arm 910 and the second section 924 of the second arm 920 are open enough to receive a torque tube 940 unobtrusively. The open state may be kept by one or more structures or functions, such as a torsional spring disposed at each pivot axis, a friction fit at each pivot axis, a weight balance for each arm, etc. For example, the first section 912 and the second section 914 of the first arm 910 may be weight balanced such that the second section 914 is in the open state due to the weight of the first section 912 when the first arm is free-swinging. The second arm 920 may have a similar weight balance between the first section 922 and the second section 924.

Specifically, the first section 912 of the first arm 910 and the first section 922 of the second arm 920 are offset to avoid interference when the first arm 910 and the second arm 920 are rotated into a closed state. When the torque tube 940 moves toward the rail body 905, the torque tube 940 pushes the first section 912 of the first arm 910 and the first section 922 of the second arm 920, thus pivoting the first arm 910 and the second arm 920 toward the closed state.

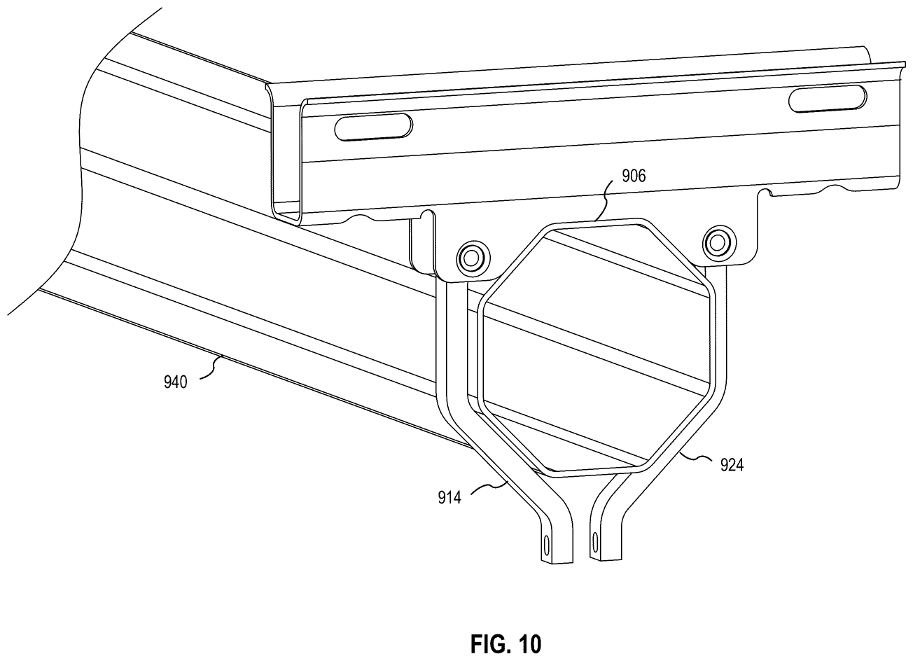

FIG. 10 shows a self-closing rail with push arms in a closed state in accordance with various embodiments of the invention. In the closed state, the torque tube is tightly embraced by the rail body 905, the first arm 910, and the second arm 920. As shown in FIG. 10, the torque tube 940 has an octagonal cross-section shape. The second section 914 of the first arm 910 and the second section 924 of the second arm 920 both have a bend with an octagonal bent angle (135°) to match the octagonal cross-section shape. Furthermore, the rail body 905 has an indent 906 that partially matches the octagonal cross-section shape of the torque tube. All the aforementioned matchings ensure a tight fit of the torque tube, and also prevents tube rotation after installation. Additionally, the first arm 910 and the second arm 920 may be securely bolted together to lock the torque tube in position.

It shall be noted that although the rail arms in certain embodiments are used to hold an octagonal torque tube, other shapes of rail arms may also be used to hold different torque tubes, including but not limited to round, oval, square tubes. The rail arms may be made from steel, aluminum, metal alloy, acrylonitrile butadiene styrene (ABS), nylon, polytetrafluoroethylene (PTFE), or any other materials that are suitable for durable outdoor usage.

It will be appreciated by those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A self-closing rail comprising:
a rail body;
a first rail arm coupled to the rail body at a first pivot axis; and
a second rail arm coupled to the rail body at a second pivot axis;
wherein the first and the second rail arms are in an open state to enable a torque tube to be moved within an open area between the first and the second rail arms; and
wherein a movement of the torque tube toward the rail body causes the first and the second rail arms to be pivoted into a closed state around the torque tube.

2. The self-closing rail of claim 1, wherein the first and second rail arms have a shape matching or partially matching a cross-section of the torque tube.

3. The self-closing rail of claim 2, wherein the cross-section of the torque tube has an octagon, round, oval, or square shape.

4. The self-closing rail of claim 1, wherein the first rail arm has an end that faces an end of the second rail arms when the first and the second rail arms are in the closed state such that the first and the second rail arms is able to be securely held together to lock the torque tube.

5. The self-closing rail of claim 1, wherein the first pivot axis is between a first section and a second section of the first rail arm, the second pivot axis is between a first section and a second section of the second rail arm.

6. The self-closing rail of claim 5, wherein the first rail arm and the second rail arm are kept in the open state by a torsional spring disposed at each pivot axis, a friction fit at each pivot axis, a weight balance between the first section and the second section of the first rail arm, a weight balance between the first section and the second section of the second rail arm, or a combination thereof.

7. The self-closing rail of claim 1, wherein the one or more mechanical structures comprise a spring engaged between the first rail arm and the second rail arm to keep the first and the second rail arms in the open position by default.

8. The self-closing rail of claim 7, wherein the spring is a leaf spring having an arc section facing toward the open area between the first arm and the second arm, when a torque tube is moved toward the rail body for installation, the torque tube pushes the spring to expand and causes the first and the second rail arms pivotably rotated to the closed state to hold the torque tube.

9. The self-closing rail of claim 1, wherein the one or more mechanical structures comprise a friction fit or a torsional spring at each pivot axis to keep the first and the second rail arms in the open position by default.

10. The self-closing rail of claim 9, wherein each of the first and the second rail arms comprises a cam, the cam touches the torque tube when the torque tube moves towards the rail body, a static friction between the torque tube and the cam causes the cam to follow the surface of the torque tube, resulting in a closed state for the arms.

11. A method of solar module-to-torque tube installation, the method comprising:
coupling a panel frame of a solar panel to a rail body of a self-closing rail, the self-closing rail comprising a first rail arm pivotably coupled to the rail body at a first pivot axis and a second rail arm pivotably coupled to the rail body at a second pivot axis;
maintaining the first rail arm and the second rail arm in an open state having an open area between the first and the second rail arms in which a torque tube is positioned; and
moving the torque tube in a first direction within the open area resulting the first and the second rail arms to pivot to a closed state around the torque tube.

12. The method of claim 11, wherein the first and second rail arms have a shape matching or partially matching a cross-section of the torque tube.

13. The method of claim 12, wherein the cross-section of the torque tube has an octagon, round, oval, or square shape.

14. The method of claim 11, further comprising:
securely holding an end of the first rail arm and an end of the second railarm together to lock the torque tube in place when the first and the second rail arms are in the closed state.

15. The method of claim 11, wherein the first pivot axis is between a first section and a second section of the first rail arm, the second pivot axis is between a first section and a second section of the second rail arm.

16. The method of claim 15, wherein the first rail arm and the second rail arm are kept in the open state by a torsional spring disposed at each pivot axis, a friction fit at each pivot axis, a weight balance between the first section and the second section of the first rail arm, a weight balance between the first section and the second section of the second rail arm, or a combination thereof.

17. The method of claim 11, wherein the one or more mechanical structures comprise a spring engaged between the first rail arm and the second rail arm to keep the first and the second rail arms in the open position by default.

18. The method of claim 17, wherein the spring is a leaf spring having an arc section facing toward the open area between the first arm and the second arm, when a torque tube is moved toward the rail body for installation, the torque tube pushes the spring to expand and causes the first and the second rail arms pivotably rotated to the closed state to hold the torque tube.

19. The method of claim 11, wherein the one or more mechanical structures comprise a friction fit or a torsional spring at each pivot axis to keep the first and the second rail arms in the open position by default.

20. The method of claim 19, wherein each of the first and the second rail arms comprises a cam, the cam touches the torque tube when the torque tube moves towards the rail body, a static friction between the torque tube and the cam causes the cam to follow the surface of the torque tube, resulting in a closed state for the arms.
